(19) United States
(12) Patent Application Publication
(10) Pub. No.: US 2011/0147239 A1
(43) Pub. Date: Jun. 23, 2011

(54) Unitizing Label and Handle for Multiple Packages

(76) Inventors: Thomas Daniel Arkins, Ridgefield, CT (US); Robert Sosnowski, Monroe, NY (US)

(21) Appl. No.: 12/643,808

(22) Filed: Dec. 21, 2009

(51) Int. Cl. B65D 71/00; B65D 77/00; G09F 3/00

(52) U.S. Cl. 206/216; 206/494; 29/428; 40/674

(57) ABSTRACT

A unitizing label and handle for multiple packages bundles two or more adjacent packages, which may contain wet wipes for consumer use. A label is at least partially affixed to the two or more adjacent packages in order to retain them, the label adapted for separating at locations between each adjacent pair of the two or more adjacent packages to facilitate removal of a package. The label may also have a handle portion at least partially separable from the label such that the handle in a first position is generally parallel with the label such that it has a low profile, and in a second separated position the handle allows a user to grasp the label and carry the two or more adjacent packages.

### BACKGROUND OF THE INVENTION

A wet wipe, also known as a wet nap, wet towel or a moist towelette, is a small moistened piece of paper or cloth that often comes folded in a package or individually wrapped for convenience. While wet wipes have become a standard part of diaper changing kits, they also serve a number of household purposes. They are typically used for cleansing, sanitizing, treating, or disinfecting. Wet wipes are generally moistened with a product-specific solution.

Wet wipes offer a versatile and efficient method for the delivery of liquids to surfaces whether for personal hygiene, cleansing, disinfection or treatment. Wipes can be used on surfaces or for personal use in every room of the house including toilet seats and flush handles, bathroom sinks, counters and faucet handles, kitchen countertops, exterior appliances surfaces, stoves, refrigerator handles, door knobs, telephones, non-wood desk surfaces, diaper pails, stair case banisters, pet areas, and even TV remote controls.

For consumers, portability adds to the appeal of pre-moistened wipes in today's mobile, fast-paced culture. Wipes can be used at home, at the gym, outdoors, and while traveling or dining out. For healthcare professionals on the go, the portable delivery system is critical. Wet wipes are typically packaged in tubs formed from rigid material. Flow wrap or “soft pack” packages have been used to supply refills of wet wipes for use with traditional tub products or even as stand-alone dispensers.

Fears over the spread of disease, such as swine or bird flu, have increased the use of disinfecting wet wipes in recent years. In addition, the spread of big box stores that sell products in bulk have further increased the sale of wet wipe products.

A need exists to address problems associated with efficiently packing wet wipe products for individual use in a bulk or multiple pack configuration that is acceptable and convenient for consumer distribution. Therefore, it would be beneficial to have a superior alternative to bags, bands or boxes for distributing multiple packages.

### SUMMARY OF THE INVENTION

The needs set forth herein as well as further and other needs and advantages are addressed by the present embodiments, which illustrate solutions and advantages described below.

The bundle of packages of the present embodiment includes, but is not limited to: two or more adjacent packages, with or without wipes (e.g., empty refill container), for consumer use, each of the two or more adjacent packages having a generally rectangular shape with a long side and a short side and positioned adjacent to each other such that their long sides and short sides align with each other, and a label having a first side and a second side, the second side of the label at least partially affixed to the two or more adjacent packages in order to retain them, the label adapted for separating at locations between each adjacent pair of the two or more adjacent packages to facilitate removal of an individual package, and the label further having a handle portion at least partially separable from the label, wherein the handle of the label in a first position is generally parallel with the label such that it has a low profile, and wherein in a second separated position the handle of the label allows a user to grasp the label and carry the two or more adjacent packages. The label may be oriented on the long, short, or even both sides of the stack. Furthermore, the label may wrap around the horizontal side panel and attach to the top and/or bottom of the stack.

The method of manufacturing a bundle of packages, includes, but is not limited to: arranging two or more packages adjacent to each other, each package having a plurality of wet or dry wipes, and affixing a label to each of the two or more packages to retain them, the label adapted for separating at locations between each adjacent pair of the two or more adjacent packages to facilitate removal of a package, and each label further having a handle portion at least partially separable from the label, wherein the handle of the label in a first position is generally parallel with the label such that it has a low profile, and wherein in a second separated position the handle of the label allows a user to grasp the label and carry the two or more adjacent packages.

Other embodiments of the label and method of manufacturing are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is an end view perspective of four wet wipe packages coupled together with one embodiment of a label according the present teachings;

FIG. 2 is an end view perspective of four foil pack (flexible film flow wrapped) wet or dry wipe packages coupled together with one embodiment of a label;

FIG. 3 is a side view of two foil pack (flexible film flow wrapped) wet or dry wipe packages coupled together with one embodiment of a label;

FIG. 4 is an end view perspective of two wet wipe packages and a bonus package coupled together with one embodiment of a label;

FIGS. 5A and 5B are end view perspectives of four wet wipe packages coupled together with a second embodiment of a label with a partially separable handle according the present teachings;

FIGS. 6A and 6B are end view perspectives of three wet wipe packages coupled together with a third embodiment of a label with a partially separable handle according the present teachings;

FIGS. 7A and 7B are end view perspectives of three foil pack wet wipe packages coupled together with a fourth embodiment of a label with a partially separable handle according the present teachings;

FIG. 8 is a flow chart depicting one embodiment of a method of manufacturing a bundle of wet wipe packages according to the present teachings; and

FIG. 9 is an end view perspective of one embodiment of the label according to the present teachings.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments.

Increased fears over the spread of germs and disease, as well as the increased ability to purchase products in bulk, although not limited thereto, have lead to an increase in demand for wet wipe products. Packaging or ganging multiple units of similar or dissimilar product types and sizes together provides benefits to both the consumer, who can purchase a desirable amount of wet wipes in a unitary product at a bulk-rate price, as well as to the manufacturer, who gains increased sales and savings with easier distribution.

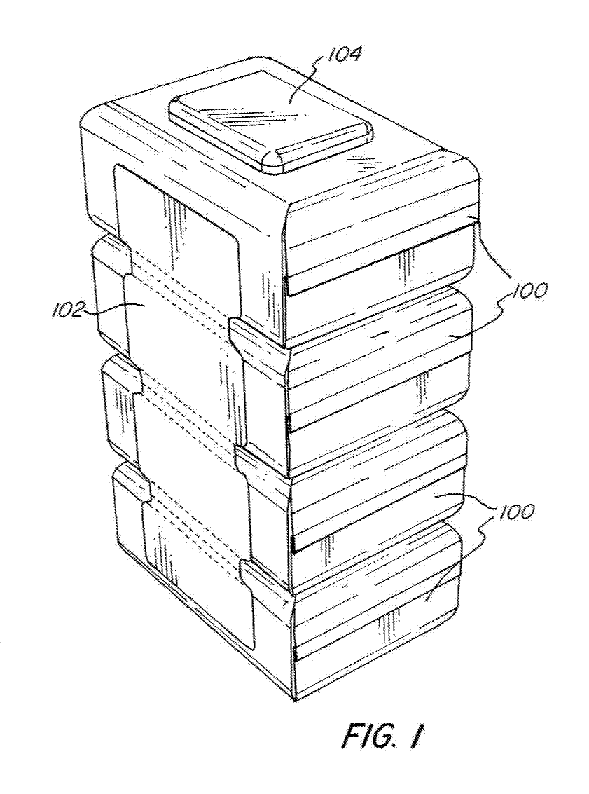

To accommodate the increased demand for wet wipes, in one embodiment, although not limited thereto, multiple wet wipe packages 100 may be stacked and the label 102 affixed to one side of the stack in order to create a unitary bundle as shown in FIG. 1. An opening 104 is typically provided on each wet wipe package 100 to allow access to the wet wipes contained therein. The label 102 is shown in a generally rectangular shape and is affixed to one side of the wet wipe packages 100. However, any shape of label 102 may be used, and the label 102 may be affixed to any part of the wet wipe packages 100 in order retain them with each other, and the present teachings are not limited to this particular embodiment.

Wet wipe packages 100 coupled together with the embodiment of a label 102 in FIG. 1 are soft packages, which may be formed from printed or non-printed laminate films comprised of multiple foil and polymeric materials, although not limited thereto. The present teachings may also be applied to rigid containers such as polyethylene bins or similar containers. One skilled in the art would appreciate that wet wipes may be packaged in any number of different packages in any number of different shapes and formed of any number of different materials and the present teachings are not limited to these particular embodiments.

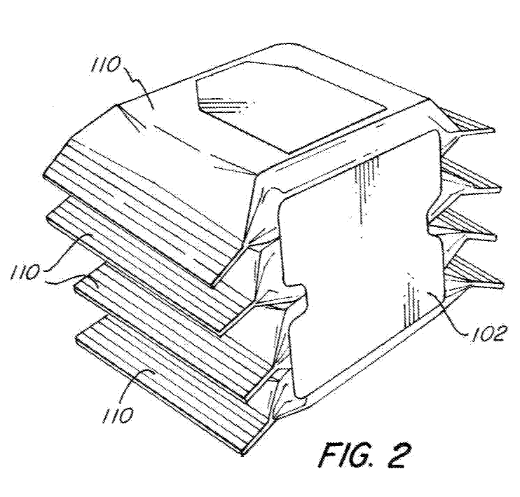

Referring now to FIG. 2, shown is an end view perspective of four laminated flexible film foil pack wet wipe packages 110 coupled together with one embodiment of a label 102. Soft packs formed from laminated flexible film are less expensive to manufacture and have traditionally been used to provide refills of wet wipes for tubs. Now they are being adapted for all uses and the use of tubs will likely be reduced over time. As such, laminated flexible film packs are in great demand by customers and a need exists to bundle multiple laminated flexible film foil pack wet wipe packages 110 for ease of distribution. One embodiment of the label 102 may be affixed to one side of the foil pack wet wipe packages 110 in a manner similar to that shown on the wet wipe packages 100 in FIG. 1. In such a way, multiple laminated flexible film foil pack wet wipe packages 110 may also be packaged for unitary sale in groups of two, three, four, five, or any other number. This may also provide sustainability opportunities with respect to multiple packages packed in flexible film bags.

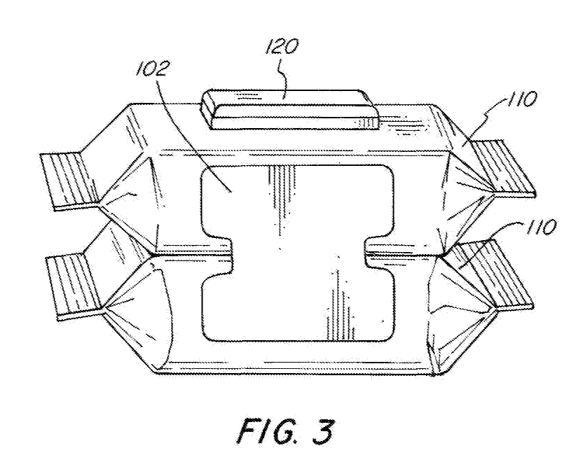

Referring now to FIG. 3, shown is a side view of two foil pack wet wipe packages 110 coupled together with one embodiment of a label 102. Foil packs have many benefits over traditional rigid tubs used for dispensing wet wipes. They generally use less material to manufacture, so they are more environmentally sound and cost-effective. In addition, they are more forgiving when packaging than rigid tubs and can be packaged and distributed more efficiently.

It is desirable to provide a moisture-lock lid 120 to a foil pack wet wipe package 110. In this way, a foil pack wet wipe package 110 is provided for stand-alone use with the benefits of ease of distribution and reseal-ability to protect the wet wipes therein. The moisture-lock lid 120 may comprise a base portion affixed to the foil pack wet wipe package 110 and a top portion hingedly affixed to the base portion, although not limited thereto. The foil pack wet wipe packages 110 may be bundled for distribution with the label 102 in a way similar to those shown in FIGS. 1 and 2, although not limited thereto.

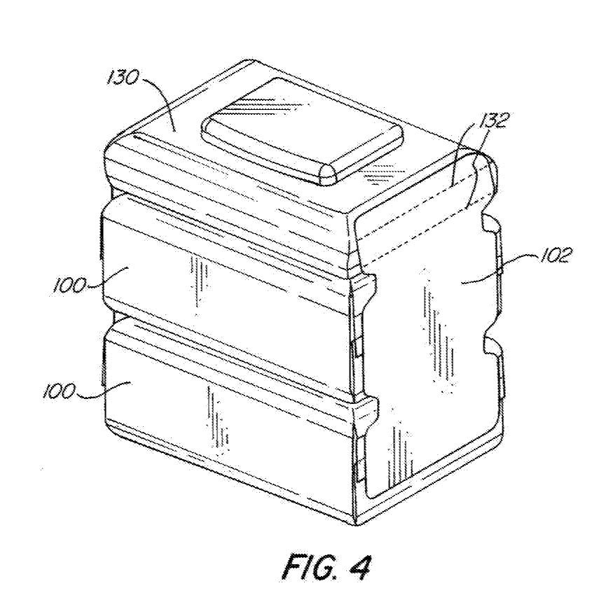

Referring now to FIG. 4, shown is an end view perspective of two wet wipe packages 100 and a bonus package 130 coupled together with one embodiment of a label 102. Bundling multiple packages together provides the ability to market different products together or to provide purchasing incentives such as including a bonus package 130. The bonus package 130 may, for example, although not limited thereto, be a new product that the manufacturer wishes to introduce to consumers. In addition, the bundles may include a variety of different products bundled and sold in a unitary way.

In one embodiment, although not limited thereto, the label 102 may have a number of perforations 132 or adapted with some other means for separating the multiple packages. Perforations 132 may be provided between each pair of adjacent wet wipe packages 100, discussed further below. This allows a consumer who purchases a bundle of wet wipe packages 100 to individually remove each individual package one at a time for use. The remaining wet wipe packages 100 are then retained with the remaining label 102 portion for continued ease of transportation and storage.

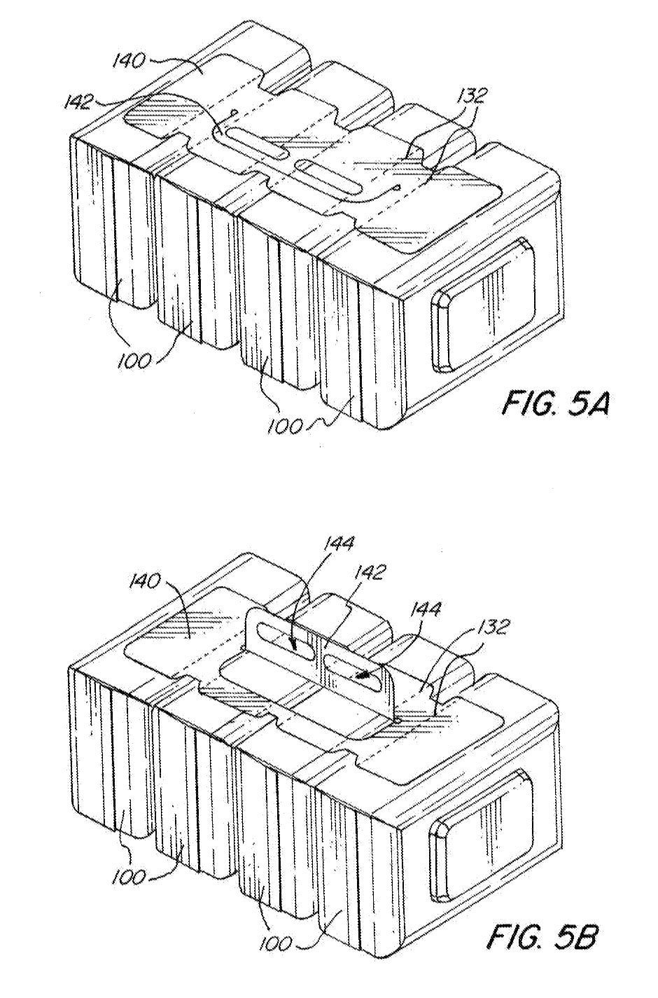

Referring now to FIGS. 5A and 5B, shown are end view perspectives of four wet wipe packages 100 coupled together with a second embodiment of a label 140 with a partially separable handle 142 according the present teachings. The label 140 may provide a partially detachable handle 142 to help consumers more easily transport bundles of multiple wet wipe packages 100.

In one embodiment, although not limited thereto, the handle 142 may be in a generally rectangular shape as shown, and be positioned along the length of the label 140. One side of the handle 142 may be partially separable from the label 140 with perforations, separations, or some similar means for allowing the handle 142 to be folded up from the label 140 as shown in FIG. 5B. The other side (e.g., non-perforated) may remain connected with the label 140 so that a user may grasp the handle 142 and transport the wet wipe packages 100. In one embodiment, although not limited thereto, handle holes 144 may be provided in the handle 142 through which a user may place fingers, a hand, or some other object to aid in transportation.

Perforations 132 may be provided on the label 140 to permit multiple wet wipe packages 100 to be easily separated from each other. The handle 142 may similarly have perforations 132 so that each individual wet wipe package may be easily removed from the bundle, yet any remaining packages may remain retained to each other and still may have the use of the remaining portion of the handle 142 to aid in transportation.

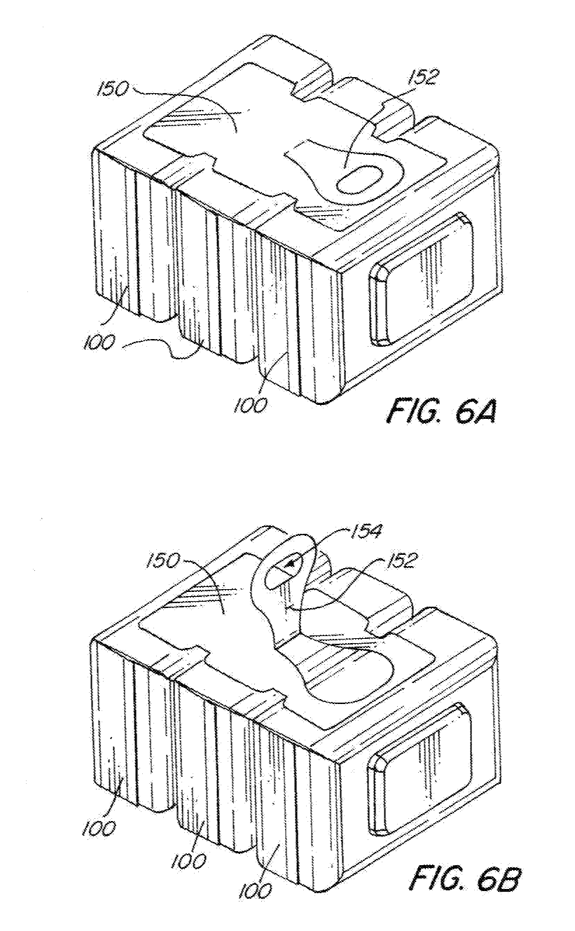

Referring now to FIGS. 6A and 6B, shown are end view perspectives of three wet wipe packages 100 coupled together with a third embodiment of a label 150 with a partially separable handle 152 according the present teachings. In this embodiment, although not limited thereto, the handle 152 may be substantially pear-shaped, with one end separable from the label 150 in order to provide a convenient means for a user to grasp and transport a bundle of multiple wet wipe packages 100. One side of the handle 152 may be partially separable from the label 150 with perforations, separations, or some similar means for allowing the handle 152 to be folded up from the label 150 as shown in FIG. 6B. The other side (e.g., non-perforated) may remain connected with the label 150 so that a user may grasp the handle 152 and transport the wet wipe packages 100. In one embodiment, although not limited thereto, a handle hole 154 or holes may be provided in the handle 152 through which a user may place fingers, a hand, or some other object to aid in transportation.

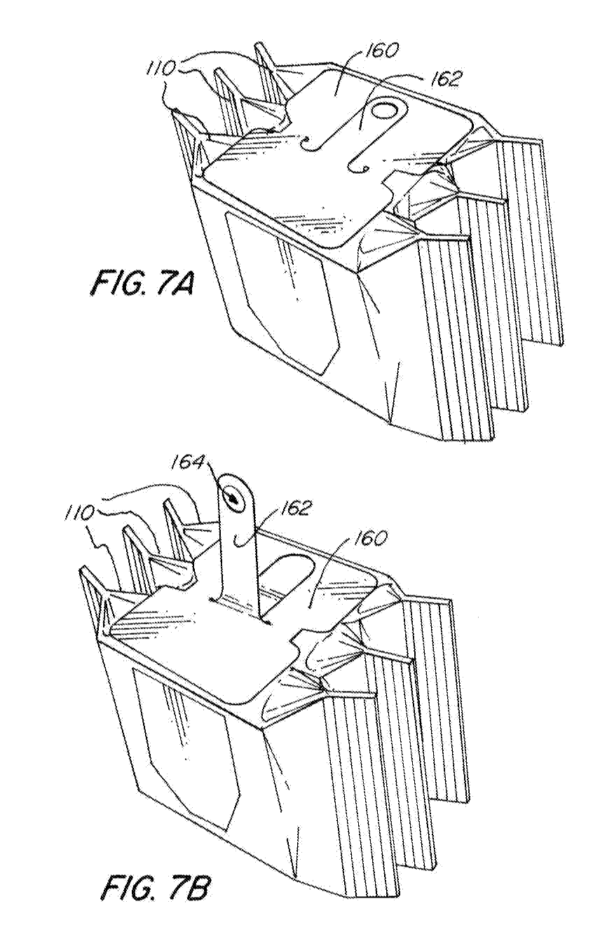

Referring now to FIGS. 7A and 7B, shown are end view perspectives of three foil pack wet wipe packages 110 coupled together with a fourth embodiment of a label 160 with a partially separable handle 162 according the present teachings. Just as other wet wipe packages 100 (shown in FIGS. 6A and 6B) may be coupled together, a label 160 may couple together multiple foil pack wet wipe packages 110 with a convenient handle 162 to aid in their transportation.

In one embodiment, although not limited thereto, the handle 162 may be in a generally oval shape as shown, and may be positioned along the length of the label 160. One side of the handle 162 may be partially separable from the label 160, with perforations, separations, or some similar means for allowing the handle 162 to be folded up from the label 160 as shown in FIG. 7B. The other side (e.g., non-perforated) may remain connected with the label 160 so that a user may grasp the handle 162 and transport the foil pack wet wipe packages 110. In one embodiment, although not limited thereto, a handle hole 164 or holes may be provided in the handle 162 through which a user may place fingers, a hand, or some other object to aid in transportation.

It is appreciated that the label 160 and the handle 162 may be configured in any number of different shapes and orientations, and the present teachings are not limited to these specific embodiments, which are provided for illustrative purposes only and are not intended to be limiting.

The label 160 may also have advertisements, coupons, or other designs thereon (not shown). In another embodiment, the label may be clear so as not to affect the design of the individual packages. It is appreciated that one skilled in the art could create any number of different label designs according to the present teachings and the present teachings are limited to these particular embodiments. For example, the label may also contain a detachable coupon.

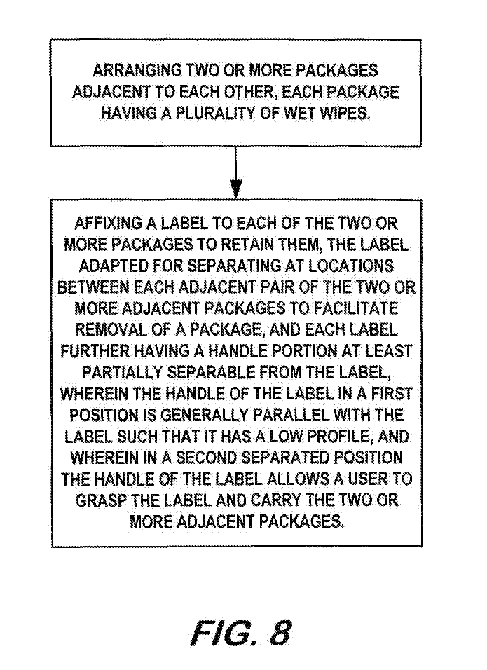

Referring now to FIG. 8, shown is a flow chart depicting one embodiment of a method of manufacturing a bundle of wet wipe packages according to the present teachings. The following steps may be performed, although not limited thereto: arranging two or more packages adjacent to each other, each package having a plurality of wet wipes, and affixing a label to each of the two or more packages to retain them, the label adapted for separating at locations between each adjacent pair of the two or more adjacent packages to facilitate removal of a package, and each label further having a handle portion at least partially separable from the label, wherein the handle of the label in a first position is generally parallel with the label such that it has a low profile, and wherein in a second separated position the handle of the label allows a user to grasp the label and carry the two or more adjacent packages.

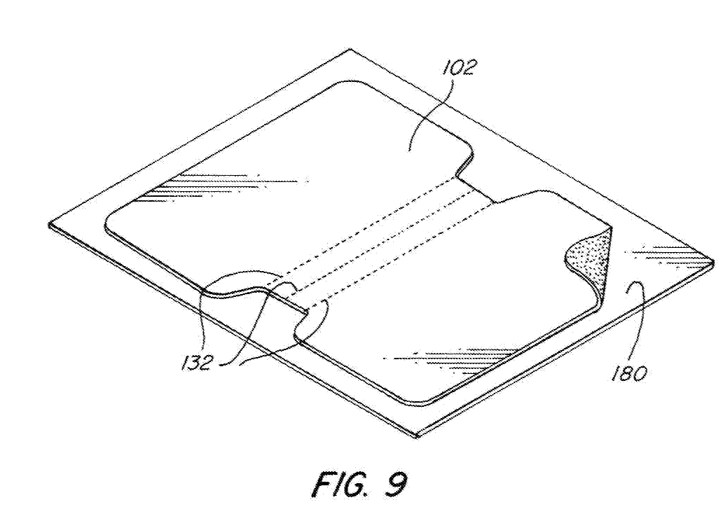

Referring not to FIG. 9, shown is an end view perspective of one embodiment of the label 102 according to the present teachings. Label 102 is shown with a number of perforations 132 and removably affixed to release paper 180. Release paper 180 has anti-stick characteristics which may be preferable to permit the easy removal of the label 102, which have glue or some other adherent, for example, although not limited thereto, for easy adherence to packages of wipes. During manufacturing, machinery may stack a number of packages of wipes and a label machine (not shown) may automatically adhere a label 102 to one or more sides of the stacked packages to form a bundle.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

1. A bundle of wet wipe packages, comprising:
three or more adjacent packages containing a number of wet wipes for consumer use, each of the three or more adjacent packages independent and separable and having a generally rectangular shape with a long side and a short side and positioned adjacent to each other such that their long sides and short sides align with each other, and
a label having a first side and a second side, the second side of the label affixed to the three or more adjacent packages with an adhesive in order to retain them, the label adapted for separating at perforations between each adjacent pair of the two or more adjacent packages to facilitate removal of a package from the three or more adjacent packages such that any remaining packages stay retained, and the label further having a handle portion at least partially separable from the label,
wherein the handle of the label in a first position is generally parallel with the label such that it has a low profile, and wherein in a second separated position the handle of the label allows a user to grasp the label and carry the three or more adjacent packages,
the handle comprises a hole to aid in carrying the three or more adjacent packages, and
the three or more adjacent packages comprises one or more soft packs constructed from a non-rigid material and having with a moisture-lock lid.

2. The bundle of claim 1, wherein the three or more adjacent packages comprises at least four packages.

3. The bundle of claim 1, wherein the three or more adjacent packages comprise at least two different wet wipe products.

4. The bundle of claim 1, wherein the label has advertising on its first side.

5. The bundle of claim 4, wherein the advertising comprises a detachable coupon.

6. (canceled)

7. (canceled)

8. (canceled)

9. The bundle of claim 1, wherein at least one of the two or more adjacent packages is a foil pack.

10. (canceled)

11. The bundle of claim 1, wherein the label is affixed to the long side of the two or more adjacent packages.

12. The bundle of claim 1, further comprising a second label affixed to the two or more adjacent packages to further aid in retaining them.

13. (canceled)

14. The bundle of claim 1, wherein the label is in a generally rectangular shape with a short side and a long side and wherein the handle is in a generally rectangular shape with a short side and a long side, such that the long sides and short sides of the label and handle are generally aligned with each other, and wherein one long side of the handle is separable from the label so that the handle can be folded away from the label and provides a convenient way to carry the two or more adjacent packages.

15. The bundle of claim 1, wherein the handle is in a generally pear shape with a wide end and a narrow end, and wherein the wide end of the handle is separable from the label so that the handle can be folded away from the label and provides a convenient way to carry the two or more adjacent packages.

16. The bundle of claim 1, wherein the label is in a generally rectangular shape with a short side and a long side and wherein the handle is in a generally oval shape with a short side and a long side, such that the long sides and short sides of the label and handle are generally aligned with each other, and wherein one short side of the handle is separable from the label so that the handle can be folded away from the label and provides a convenient way to carry the two or more adjacent packages.

17. A label for bundling packages of wet wipes, comprising:
the label having a first side, a second side, and a handle portion at least partially separable from the label,
wherein the second side of the label is affixed to three or more packages of wet wipes with an adhesive in order to retain them, the three or more packages independent and separable, and further wherein the label is adapted for separating at perforations between each adjacent pair of the three or more adjacent packages to facilitate removal of a package from the three or more packages such that any remaining packages stay retained, and further wherein the handle of the label in a first position is generally parallel with the label such that it has a low profile and in a second separated position the handle of the label allows a user to grasp the label and carry the three or more adjacent packages,
the handle comprises a hole to aid in carrying the three or more adjacent packages, and
the three or more adjacent packages comprises one or more soft packs constructed from a non-rigid material and having with a moisture-lock lid.

18. The label of claim 17 further comprising an easy release surface, wherein the second side of the label is removable affixed to the easy release surface.

19. The label of claim 18 wherein the easy release surface comprises release paper.

20. A method of manufacturing a bundle of wet wipe packages, the method comprising the steps of:
arranging three or more packages adjacent to each other, each package independent and separable and having a plurality of wet wipes, and
affixing a label to each of the three or more packages with an adhesive to retain them, the label adapted for separating at perforations between each adjacent pair of the three or more adjacent packages to facilitate removal of a package from the three or more adjacent packages such that any remaining packages stay retained, and each label further having a handle portion at least partially separable from the label,
wherein the handle of the label in a first position is generally parallel with the label such that it has a low profile, and wherein in a second separated position the handle of the label allows a user to grasp the label and carry the two or more adjacent packages,
the handle comprises a hole to aid in carrying the three or more adjacent packages,
the three or more adjacent packages are soft packs constructed from a non-rigid material, and
each of the three or more adjacent packages has a moisture-lock lid.
